(19) United States
(12) Patent Application Publication
(10) Pub. No.: US 2017/0108635 A1
(43) Pub. Date: Apr. 20, 2017

(54) BACKLIGHT MODULE WITH NON-PLANAR LATERAL STRUCTURE AND LIQUID CRYSTAL DISPLAY APPARATUS USING THE SAME

(71) Applicant: WUHAN CHINA STAR OPTOELECTRONICS TECHNOLOGY CO., LTD., Wuhan (CN)

(72) Inventors: Qian Chen, Wuhan (CN); Qing Guo, Wuhan (CN); Xingling Guo, Wuhan (CN)

(73) Assignee: WUHAN CHINA STAR OPTOELECTRONICS TECHNOLOGY CO., LTD.

(21) Appl. No.: 14/994,187

(22) Filed: Jan. 13, 2016

(30) Foreign Application Priority Data
Oct. 20, 2015 (CN) 201510684127.4

(51) Int. Cl. F21V 8/00

(52) U.S. Cl. CPC G02B 6/0031; G02B 6/0055; G02B 6/0088

(57) ABSTRACT

A backlight module with a non-planar lateral structure and LCD apparatus using the same are described. The backlight module comprises a light source; and a light guide body comprising a lateral incident surface and a non-planar lateral structure adjacent to the emitting surface and the bottom surface therebetween; wherein the non-planar lateral structure is opposite lateral incident surface, and a first incident light and a second incident light pass through the lateral incident surface and enter the light guide body; and wherein the non-planar lateral structure reflects and refracts the first incident light so that the reflected and refracted light of the first incident light returns from the non-planar lateral structure back to the light guide body, and the returned first incident light and the second incident light are reflected again from the bottom surface and emitted from the emitting surface to an LCD panel.

### BACKGROUND OF THE INVENTION

Field of Invention

The present invention relates to a technical field of a display, and more particularly to a backlight module with a non-planar lateral structure and liquid crystal display (LCD) apparatus using the same.

Description of Prior Art

With enhanced efficiency of light-emitted diode (LED), the design of backlight source using LED has been improved automatically. From the earliest four-side and double-side light incident mode to current single-side light incident mode, current and future development will aim at the single-side light incident mode.

Please refer to FIG. 1, which is a schematic view of conventional LCD apparatus. The LCD apparatus includes a display panel 10, a frame 12, an optical film assembly 14, a light guide plate (LGP) 16, a reflection plate 18 and a light-shading tape 20. In order to increase the light efficient utilization, the conventional backlight uses the frame 12 which is made of polycarbonate plastic (PC). However, the PC material has a high reflective index and thus the light emitting from the edge 16a of LGP 16 will be reflected back to LGP 16 or optical film. After the light is refracted, a portion of light L1 cannot be sheltered by the light-shading tape 20 such that the portion of light L1 is emitted to the active area (AA) at an angle wherein the angle is smaller than a viewing angle. In such case, the user will see the light leakage in the active area within the viewing angle. Furthermore, another portion of light L2 is reflected on the side of the frame 12, which decreases the light utilization efficiency. Consequently, there is a need to develop a novel LCD apparatus to solve the problems of the backlight leakage and low light utilization efficiency.

### SUMMARY OF THE INVENTION

Therefore, one objective of the present invention is to provide a backlight module with a non-planar lateral structure and liquid crystal display apparatus using the same wherein the non-planar lateral structure of a light guide body is capable of changing the transmission path of the incident light to raise the light utilization efficiency for decreasing or eliminating the light leakage near the side portion of backlight module.

Based on the above objective, the present invention sets forth a backlight module with a non-planar lateral structure and liquid crystal display apparatus using the same. In the first embodiment of the present invention, the backlight module with a non-planar lateral structure comprises a light source; and a light guide body comprising a lateral incident surface, an emitting surface adjacent to the lateral incident surface, a bottom surface adjacent to the lateral incident surface and opposite the emitting surface, and a non-planar lateral structure adjacent to both the emitting surface and the bottom surface therebetween; wherein the non-planar lateral structure is opposite the lateral incident surface, and a first incident light and a second incident light of the light source pass through the lateral incident surface and enter the light guide body; and wherein the non-planar lateral structure is used to reflect and refract the first incident light, which is emitted into the non-planar lateral structure, so that the reflected and refracted light of the first incident light returns from the non-planar lateral structure back to the light guide body therein, and the returned first incident light and the second incident light are reflected again from the bottom surface and are emitted from the emitting surface to a liquid crystal display (LCD) panel.

In one embodiment, the non-planar lateral structure is selected from one group consisting of a prism lateral surface, a regular curved surface, an irregular curved surface and the combinations.

In one embodiment, the reflection plate is connected to the bottom surface of the light guide body for reflecting the first incident light to the non-planar lateral structure and for reflecting the returned first incident light and the second incident light to the emitting surface.

In one embodiment, the backlight module of claim further comprises: an optical film assembly disposed on the emitting surface of the light guide body for adjusting the first incident light and the second incident light, which passes through the emitting surface; a frame disposed around the light guide body, for surrounding and fastening the light guide body; and a light-shading type which is fastened on the frame and disposed above the non-planar lateral structure, wherein the light-shading type is overlapped on the non-planar lateral structure along a horizontal width direction of the light-shading type.

In one embodiment, a side portion of the non-planar lateral structure either aligns to or does not align to an edge of the optical film assembly so that the non-planar lateral structure is capable of reflecting and scattering the first incident light back to the light guide body.

In the second embodiment of the present invention, an LCD apparatus comprises a backlight module and a LCD panel disposed on the backlight module, wherein the backlight module comprises a light source; and a light guide body comprising a lateral incident surface, an emitting surface adjacent to the lateral incident surface, a bottom surface adjacent to the lateral incident surface and opposite the emitting surface, and a non-planar lateral structure adjacent to both the emitting surface and the bottom surface therebetween; wherein the non-planar lateral structure is opposite the lateral incident surface, and a first incident light and a second incident light of the light source pass through the lateral incident surface and enter the light guide body; and wherein the non-planar lateral structure is used to reflect and refract the first incident light, which is emitted into the non-planar lateral structure, so that the reflected and refracted light of the first incident light returns from the non-planar lateral structure back to the light guide body therein, and the returned first incident light and the second incident light are reflected again from the bottom surface and emitted from the emitting surface to a liquid crystal display (LCD) panel.

In one embodiment, the non-planar lateral structure is selected from one group consisting of a prism lateral surface, a regular curved surface, an irregular curved surface and the combinations.

In one embodiment, the reflection plate is connected to the bottom surface of the light guide body for reflecting the first incident light to the non-planar lateral structure and for reflecting the returned first incident light and the second incident light to the emitting surface.

In one embodiment, the LCD apparatus further comprises an optical film assembly disposed on the emitting surface of the light guide body for adjusting the first incident light and the second incident light, which passes through the emitting surface; a frame disposed around the light guide body, for surrounding and fastening the light guide body; and a light-shading type which is fastened on the frame and disposed above the non-planar lateral structure, wherein the light-shading type is overlapped on the non-planar lateral structure along a horizontal width direction of the light-shading type.

In one embodiment, a side portion of the non-planar lateral structure either aligns to or does not align to an edge of the optical film assembly so that the non-planar lateral structure is capable of reflecting and scattering the first incident light back to the light guide body.

### BRIEF DESCRIPTION OF THE DRAWINGS

FIG. 1 is a schematic view of conventional LCD apparatus; and

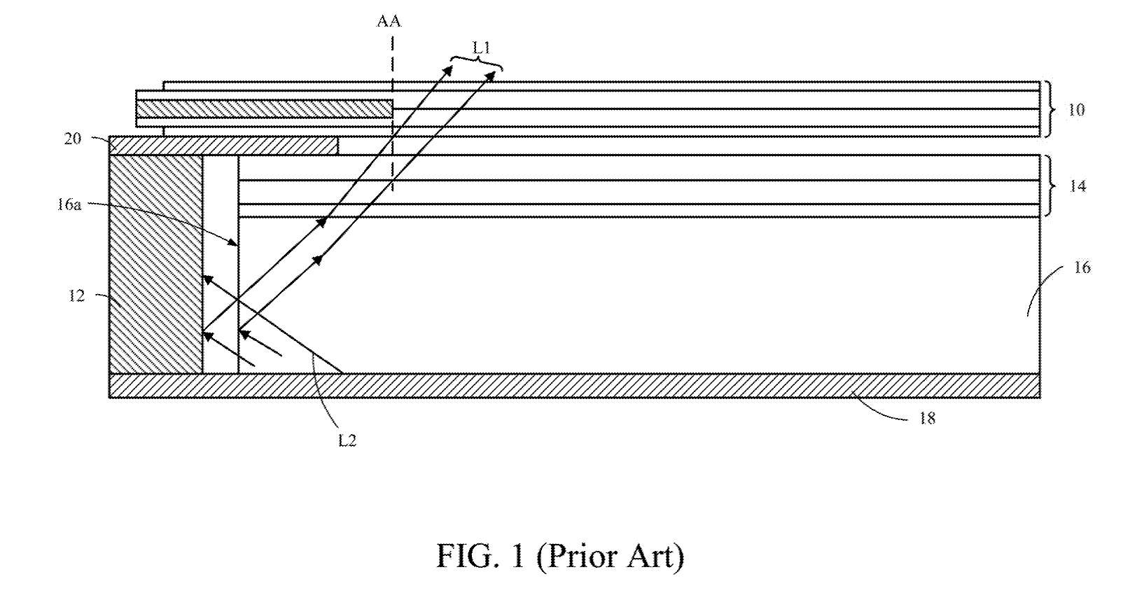

FIG. 2 is a schematic view of LCD apparatus having a backlight module with a non-planar lateral structure according to one embodiment of the present invention.

### DETAILED DESCRIPTION OF THE PREFERRED EMBODIMENTS

The following embodiments refer to the accompanying drawings for exemplifying specific implementable embodiments of the present invention. Furthermore, directional terms described by the present invention, such as upper, lower, front, back, left, right, inner, outer, side, etc., are only directions by referring to the accompanying drawings, and thus the used directional terms are used to describe and understand the present invention, but the present invention is not limited thereto.

In the drawings, the same reference symbol represents the same or a similar component.

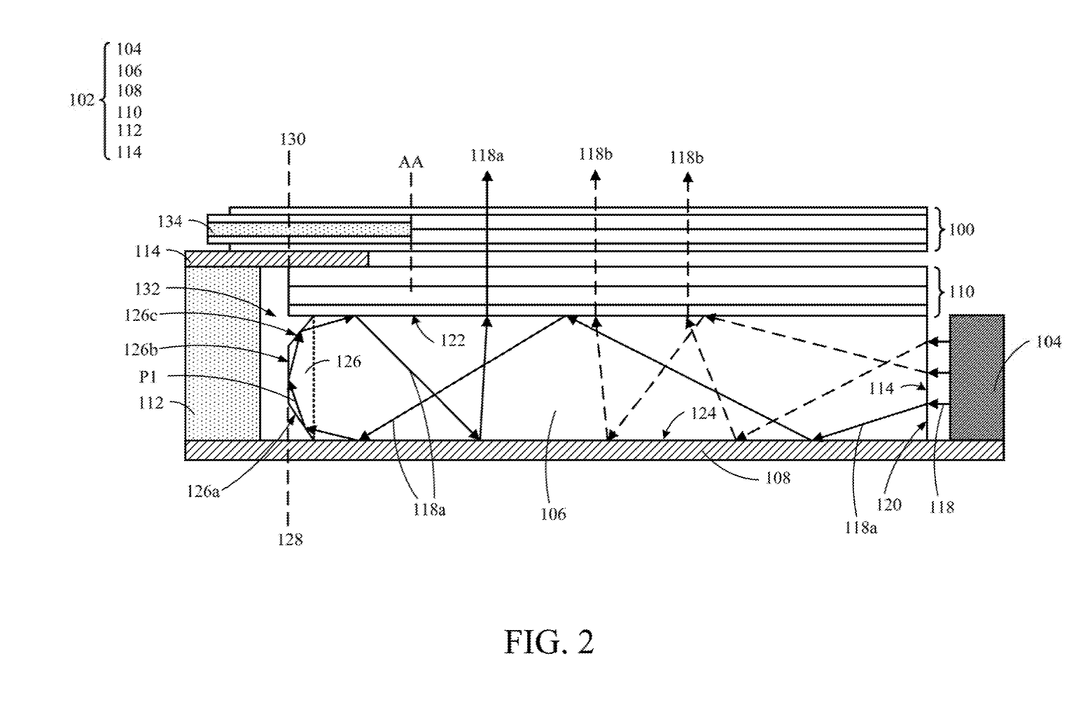

Please refer to FIG. 2. FIG. 2 is a schematic view of LCD apparatus having a backlight module with a non-planar lateral structure according to one embodiment of the present invention. The LCD apparatus comprises LCD panel and backlight module 102. The backlight module 102 comprises a light source 104, a light guide body 106, a reflection plate 108, an optical film assembly 110, a frame 112 and a light-shading tape 114. The light source 104 is disposed on the reflection plate 108 and located near the lateral side of the light guide body 106 for generating the incident light 118 to be inputted to the light guide body 106. For example, the light source 104 is an LED. The light guide body 106 is disposed on the reflection plate 108 and positioned near the frame 112. The optical film assembly 110 is disposed on the light guide body 106. The bottom portion of the frame 112 is disposed on the reflection plate 108 and the frame 112 is used to surround the light guide body 106 and the optical film assembly 110. The light-shading tape 114 is disposed on the frame 112 and covers a portion of upper surface of optical film assembly 110.

As shown in FIG. 2, the light guide body 106 comprises a lateral incident surface 120, an emitting surface 122 adjacent to the lateral incident surface 120, a bottom surface 124 adjacent to the lateral incident surface 120 and opposite the emitting surface 122, and a non-planar lateral structure 126 adjacent to both the emitting surface 122 and the bottom surface 124 therebetween. The non-planar lateral structure 126 is opposite the lateral incident surface 120. The first incident light 118a and second incident light 118b of the light source 104 pass through the lateral incident surface 120 and enter the light guide body 106 wherein the non-planar lateral structure 126 is used to reflect and refract the first incident light 118a, which is emitted into the non-planar lateral structure 126, so that the reflected and refracted light of the first incident light 118a returns from the non-planar lateral structure 126 back to the light guide body 106 therein. Thus, the returned first incident light 118a and the second incident light 118b are reflected again from the bottom surface 124 and are emitted from the emitting surface 122 to the LCD panel 100.

Basically, after the incident light, e.g. the first incident light 118a and the second incident light 118b, generated by the light source 104 is reflected and adjusted, the adjusted light is uniformly and sequentially emitted from the emitting surface 122 of light guide body 106 to the optical film assembly 110 and LCD panel 100 for the display of the LCD. In FIG. 2, while the first incident light 118a reflects on the reflection plate 108, the reflected incident light 118a continuously enter the non-planar lateral structure 126 along the first path P1. The function of the non-planar lateral structure 126 is used to reflect and scatter the first incident light 118a for guiding the first incident light 118a back to the light guide body 106 to prevent the first incident light 118a near the non-planar lateral structure 126 from transmitting to the emitting surface 122, thereby causing the light leakage. In other words, the first incident light 118a near the non-planar lateral structure 126 is firstly guided back to the non-planar lateral structure 126, the first incident light 118a near the non-planar lateral structure 126 is then regulated or adjusted by the reflection plate 108. Finally, the reflection plate 108 emits the regulated light through the emitting surface 122 to avoid the light leakage near the non-planar lateral structure 126.

In one embodiment, the non-planar lateral structure 126 is selected from one group consisting of prism lateral surface, a regular curved surface, an irregular curved surface and the combinations. As shown in FIG. 2, if the non-planar lateral structure 126 is composed of prism lateral surface, the prism lateral surface is capable of reflecting, refracting and scattering the first incident light 118a such that the first incident light 118a is guided and returns the light guide body 106. In one case, the prism lateral surface includes a first side surface 126a connected to the bottom surface 124, a second side surface 126b connected to the first side surface 126a, and a third side surface 126c disposed between the second side surface 126b and the emitting surface 122. The first incident light 118a on the reflection plate 108 and the bottom surface 124 are reflected, e.g. internal total reflection, and scattered among the first side surface 126a, second side surface 126a and third side surface 126c in order to eliminate or reduce the direct emission of the first incident light 118a to the optical film assembly 110 and LCD panel 100 from the non-planar lateral structure 126, or eliminate or reduce the direct emission of the first incident light 118a to the optical film assembly 110 and LCD panel 100 from the frame 112. The present invention utilizes the eliminate or reduce the direct emission of the first incident light 118a to the optical film assembly and LCD panel 100 from the non-planar lateral structure 126 to smoothly reflect and scatter the first incident light 118a to be returned back to the light guide body 106 from the emitting surface 122. In other words, the prism later surface can smoothly guide the light to the non-planar lateral structure 126 and the guided light return the light guide body 106. In another embodiment, the non-planar lateral structure 126 is a regular curved surface to reflect, refract and scatter the first incident light 118a so that the first light incident 118a returns back to light guide body 106. Still in one embodiment, the non-planar lateral structure 126 is the irregular curved surface to reflect, refract and scatter the first incident light 118a so that the first light incident 118a returns back to light guide body 106.

As shown in FIG. 2, the reflection plate 108 is connected to the bottom surface 124 of the light guide body 106 for reflecting the first incident light 118a to the non-planar lateral structure 126 and reflecting the returned first incident light 118a and the second incident light 118b to the emitting surface 122. In one embodiment, the upper surface of the reflection plate 108 is adhered to the frame 112 and the bottom surface 124 of light guide body 106 and a plurality of mesh points (not shown) on the surface of the reflection plate 108 for uniformly scattering and reflecting the light. In one embodiment, the bottom surface 124 guides the first incident light 118a from the reflection plate 108 to the first side surface 126a. The first incident light 118a on the first side surface 126a then passes the second side surface 126b, the third side surface 126c and the emitting surface 122. Afterwards, the returned first incident light 118a is reflected on the reflection plate 108 again. Finally, the returned first incident light 118a on the mesh points of the reflection plate 108 is transmitted to the emitting surface 122.

In FIG. 2, the optical film assembly 110 of the backlight module 102 is disposed on and connected to the emitting surface 122 of the light guide body 106 for adjusting the first and second incident light 118a, 118b which passes through the emitting surface 122. In one embodiment, the optical film assembly 110 is prism film or diffusion film.

As shown in FIG. 2, in one embodiment, the side portion 128 of the non-planar lateral structure 126 either aligns to or does not align to the edge 130 of the optical film assembly 130 so that the non-planar lateral structure 126 is capable of reflecting and scattering the first incident light 118a back to the light guide body 106. When the side portion 128 of the non-planar lateral structure 126 does not align to the edge 130 of the optical film assembly 130, the side portion 128 of the non-planar lateral structure 126 will forms a protrusion or shrinking portion in relation the edge 130 of the optical film assembly 130.

In FIG. 2, the backlight module 102 further includes a frame 112 which is disposed around the light guide body 106 for surrounding and fastening the light guide body 106. In other words, the bottom portion of the frame 112 is disposed on the reflection plate 108 and surrounds the light guide body 106 and optical film assembly. A light-shading tape is disposed on the frame 112. In one embodiment, an interval gap is formed between an internal side of the frame 112 and the side portion of the light guide body 106. That is, a space 132 is formed between internal side of the frame 112 and the side portion 128 of the non-planar lateral structure 126.

As shown in FIG. 2, the backlight module 102 further includes a light-shading type 114 which is fastened on the frame 112 and disposed above the non-planar lateral structure 126 wherein the light-shading type 114 is overlapped on the non-planar lateral structure 126 along a horizontal width direction of the light-shading type 114. The light-shading type 114 is used to shelter the reflected light, e.g. the first and second incident light, from the internal side of the frame 112.

In FIG. 2, the LCD panel 100 further comprises a shading region 134 for sheltering a portion of leakage light and defines the active area. The present invention employs the non-planar lateral structure 126 connected to the light guide body 106 to change the transmission path of the incident light in order to reduce the widths of the light-shading type 114 and the shading region 134 so that the active area of the LCD is increased to raise the viewing region of the LCD and thus form an LCD with a narrow frame.

According to the above-mentioned descriptions, the backlight module with a non-planar lateral structure and liquid crystal display using the same is capable of changing the transmission path of the incident light to raise the light utilization efficiency for decreasing or eliminating the light leakage near the side portion of backlight module.

As is understood by a person skilled in the art, the foregoing preferred embodiments of the present invention are illustrative rather than limiting of the present invention. It is intended that they cover various modifications and similar arrangements be included within the spirit and scope of the present invention, the scope of which should be accorded the broadest interpretation so as to encompass all such modifications and similar structures.

What is claimed is:

1. A backlight module, comprising:
a light source; and
a light guide body comprising a lateral incident surface, an emitting surface adjacent to the lateral incident surface, a bottom surface adjacent to the lateral incident surface and opposite the emitting surface, and a non-planar lateral structure adjacent to both the emitting surface and the bottom surface therebetween;
wherein the non-planar lateral structure is opposite the lateral incident surface, and a first incident light and a second incident light of the light source pass through the lateral incident surface and enter the light guide body;
wherein the non-planar lateral structure is used to reflect and refract the first incident light, which is emitted into the non-planar lateral structure, so that the reflected and refracted light of the first incident light returns from the non-planar lateral structure back to the light guide body therein, and the returned first incident light and the second incident light are reflected again from the bottom surface and are emitted from the emitting surface to a liquid crystal display (LCD) panel.

2. The backlight module of claim 1, wherein the non-planar lateral structure is selected from one group consisting of a prism lateral surface, a regular curved surface, an irregular curved surface and the combinations.

3. The backlight module of claim 1, wherein the reflection plate is connected to the bottom surface of the light guide body for reflecting the first incident light to the non-planar lateral structure and for reflecting the returned first incident light and the second incident light to the emitting surface.

4. The backlight module of claim 1, further comprising:
an optical film assembly disposed on the emitting surface of the light guide body for adjusting the first incident light and the second incident light, which passes through the emitting surface;
a frame disposed around the light guide body, for surrounding and fastening the light guide body; and
a light-shading type which is fastened on the frame and disposed above the non-planar lateral structure, wherein the light-shading type is overlapped on the non-planar lateral structure along a horizontal width direction of the light-shading type.

5. The backlight module of claim 4, wherein a side portion of the non-planar lateral structure either aligns to or does not align to an edge of the optical film assembly so that the non-planar lateral structure is capable of reflecting and scattering the first incident light back to the light guide body.

6. An LCD apparatus comprising a backlight module and a LCD panel disposed on the backlight module, wherein the backlight module comprises:
a light source; and
a light guide body comprising a lateral incident surface, an emitting surface adjacent to the lateral incident surface, a bottom surface adjacent to the lateral incident surface and opposite the emitting surface, and a non-planar lateral structure adjacent to both the emitting surface and the bottom surface therebetween;
wherein the non-planar lateral structure is opposite the lateral incident surface, and a first incident light and a second incident light of the light source pass through the lateral incident surface and enter the light guide body;
wherein the non-planar lateral structure is used to reflect and refract the first incident light, which is emitted into the non-planar lateral structure, so that the reflected and refracted light of the first incident light returns from the non-planar lateral structure back to the light guide body therein, and the returned first incident light and the second incident light are reflected again from the bottom surface and are emitted from the emitting surface to a liquid crystal display (LCD) panel.

7. The LCD apparatus of claim 6, wherein the non-planar lateral structure is selected from one group consisting of a prism lateral surface, a regular curved surface, an irregular curved surface and the combinations.

8. The LCD apparatus of claim 6, wherein the reflection plate is connected to the bottom surface of the light guide body for reflecting the first incident light to the non-planar lateral structure and for reflecting the returned first incident light and the second incident light to the emitting surface.

9. The LCD apparatus of claim 6, further comprising:
an optical film assembly disposed on the emitting surface of the light guide body for adjusting the first incident light and the second incident light, which passes through the emitting surface;
a frame disposed around the light guide body, for surrounding and fastening the light guide body; and
a light-shading type which is fastened on the frame and disposed above the non-planar lateral structure, wherein the light-shading type is overlapped on the non-planar lateral structure along a horizontal width direction of the light-shading type.

10. The LCD apparatus of claim 9, wherein a side portion of the non-planar lateral structure either aligns to or does not align to an edge of the optical film assembly so that the non-planar lateral structure is capable of reflecting and scattering the first incident light back to the light guide body.
